(19) United States
(12) Patent Application Publication
(10) Pub. No.: US 2016/0108857 A1
(43) Pub. Date: Apr. 21, 2016

(54) APPARATUS AND METHOD OF IMPROVING VOLUMETRIC EFFICIENCY IN AN INTERNAL COMBUSTION ENGINE

(71) Applicant: WESTPORT POWER INC., Vancouver (CA)

(72) Inventor: Fadi Kanafani, Richmond (CA)

(21) Appl. No.: 14/984,961

(22) Filed: Dec. 30, 2015

Related U.S. Application Data
(63) Continuation-in-part of application No. PCT/CA2014/050625, filed on Jun. 30, 2014.

(30) Foreign Application Priority Data
Jul. 5, 2013 (CA) 2819966

(51) Int. Cl. F02M 21/06; F01P 7/14; F01P 3/02; F02B 43/04; F02D 41/00

(52) U.S. Cl. CPC F02M 21/06; F02B 43/04; F02D 41/0027; F01P 3/02; F01P 7/14; F01P 2003/021; F01P 2007/146

(57) ABSTRACT

Volumetric efficiency is reduced in a premixed gaseous fuel engine compared to a premixed liquid fuel engine. An improved method for operating an internal combustion engine and improving volumetric efficiency comprises storing a gaseous fuel in a liquid state; determining a load on the internal combustion engine as a function of engine operating conditions; determining a target temperature for the gaseous fuel that reduces the likelihood of pre-ignition and knock as a function of the load; and controlling the amount of heat transferred to the gaseous fuel to convert it to one of a gas state and a supercritical state, such that the gaseous fuel is introduced into the internal combustion engine at the target temperature.

### BACKGROUND

1. Field of the Invention

The present application relates to an apparatus and method of improving volumetric efficiency in an internal combustion engine. More particularly, the subject apparatus and method is directed to engines fuelled with a gaseous fuel that is stored at a cryogenic temperature.

2. Description of the Related Art

Automobile manufacturers are designing vehicles fuelled with alternative fuels, such as natural gas and liquefied petroleum gas (LPG), to reduce both emissions and the cost of fuelling compared to operating with gasoline and diesel. In the past, most of such alternative fuelled vehicles have stored such gaseous fuels at close to ambient temperatures, for example, as compressed natural gas (CNG). Liquefied natural gas (LNG) is becoming more accepted in many applications because of the increased energy density compared to CNG. That is, with LNG a reduced amount of space is needed to store an equivalent amount of fuel. Double-walled storage vessels that maintain a vacuum between an outer vessel and an insulated inner vessel store liquefied natural gas at or near its boiling temperature of approximately −162° C. (at a typical storage pressure between the range of 50 to 150 pounds per square inch). Liquefied natural gas is normally converted from a liquid state to a gas or supercritical state before introduction into an engine combustion chamber. A heat exchanger, commonly called a vaporizer, is an efficient means for accomplishing this conversion because it can employ engine waste heat captured by coolant in the water jacket of the engine to vaporize the liquefied natural gas. Other sources of energy can be employed to vaporize the LNG, such as an electric heater or boiler burning a fuel such as natural gas vapors.

Gasoline engines that are converted to be fuelled with natural gas normally result in a 10% to 15% reduction of delivered power with two of the main factors for this reduced power being the lower compression ratios normally associated with Otto-cycle engines versus Diesel-cycle engines, and the displacement of air caused by the introduction of natural gas. One known method to improve the volumetric efficiency of an Otto-cycle engine fuelled with natural gas is to increase the compression ratio because natural gas normally has a higher octane number (typically about 120) compared to gasoline (typically between about 88 and 92), meaning that natural gas is less prone to pre-ignition or result in engine knock. In this disclosure, “pre-ignition” is defined to occur when the air/fuel mixture in the combustion chamber ignites before the ignition source is activated, and “engine knock” or “knocking” is defined to occur when combustion of the air/fuel mixture in the combustion chamber starts off correctly in response to ignition by the ignition source, but one or more pockets of air/fuel mixture explode outside the envelope of the normal combustion front.

International Patent Publication No. WO 02,090,750A, published Nov. 14, 2002 and which identifies Scott Tritton as the inventor, (hereinafter the Tritton reference), discloses a fuel delivery system that converts a liquid fuel to a gaseous fuel, particularly for diesel engines converted to run on liquid gas. Flow of liquid coolant to a heat exchanger for converting liquid gas to vapor is controlled by a thermostatic valve which is activated by the temperature of the liquid fuel as determined by a temperature sensor in the fuel line. In one embodiment the thermostat valve has a simple open/closed operation such that below a threshold temperature the valve is opened to provide engine coolant and therefore more heat to the heat exchanger. This temperature threshold is selected at a level below which the device may inadequately gasify the fuel or provide gas at too low a temperature. The thermostat valve can also be configured to close and interrupt the flow of liquid coolant to the heat exchanger above the threshold temperature to prevent the temperature of the gas from becoming too high. In another embodiment the flow of liquid coolant to the heat exchanger is varied between full flow to nil flow between a temperature range of the fuel. The lower threshold temperature of the fuel is selected to avoid icing up of the heat exchanger, and the upper threshold temperature is selected to provide a gasified fuel. For example, in the case of liquefied petroleum gas (LPG), Tritton teaches a suitable range may commence with full flow of liquid coolant to the heat exchanger below −37° C. and may gradually decrease to interrupted or nil flow at any suitable temperature selected to prevent overheating of the gaseous fuel. It is disclosed by Tritton that a suitable effect may be obtained if the outer surface of the heat exchanger is in the range of 70° C. to 80° C., although a range of 20° C. to 100° C. may be acceptable in certain circumstances. Tritton teaches using intake air as an additional source of heat to assist with vaporizing the fuel and for lowering intake air temperature to reduce the likelihood of mistimed detonation. However, Tritton's disclosure is focused on controlling the flow of engine coolant to a vaporizer to manage the temperature of the fuel so that it vaporizes and is not heated to too high a temperature. While Tritton discloses a few embodiments that provide the additional benefit of cooling the intake air, Tritton does not teach controlling the temperature of the fuel that is being vaporized to control the temperature in the combustion chamber for improved volumetric efficiency. Tritton's primary example relates to an engine fuelled with LPG stored at about −37° C., so when one considers the mass of fuel compared to the mass of intake air, there is not a large enough temperature differential to have a significant influence on the intake charge temperature beyond helping in a limited way to reduce the likelihood of mistimed detonation. In addition, Tritton teaches using intake air to warm the fuel as a first stage, so there is no opportunity with Tritton's apparatus to control the temperature of the fuel in order to control the charge temperature.

The state of the art is lacking in techniques for improving the volumetric efficiency of gaseous-fueled internal combustion engines. The present apparatus and method provides a technique for improving the volumetric efficiency of gaseous-fueled internal combustion engines.

### BRIEF SUMMARY

An improved method for operating an internal combustion engine and improving volumetric efficiency comprises storing a gaseous fuel in a liquid state; determining a load on the internal combustion engine as a function of engine operating conditions; determining a target temperature for the gaseous fuel that reduces the likelihood of pre-ignition and knock as a function of the load; and controlling the amount of heat transferred to the gaseous fuel to convert it to one of a gas state and a supercritical state, such that the gaseous fuel is introduced into the internal combustion engine at the target temperature. The target temperature is determined to have a specific value plus or minus a predetermined range of tolerance. The target temperature can be further determined as a function of ambient temperature. The gaseous fuel temperature can be decreased as the load increases and gaseous fuel temperature can be increased as the load decreases. It is advantageous to adjust fuel temperature across the load/speed range of the engine to prevent components from freezing, such as for example throttle blades and exhaust gas recirculation valves, especially under cold ambient conditions. Throttling losses can be reduced if gaseous fuel temperature is increased at light(er) load(s) such that the overall mixture temperature is increased thereby increasing the pressure in a constrained volume. The on-time for fuel injectors is adjusted as a function of gaseous fuel temperature to correct for changes in fuel density. The gaseous fuel can be introduced upstream of an intake valve of the combustion chamber or directly into the combustion chamber. When the gaseous fuel is directly introduced into the combustion chamber, at least a portion of the gaseous fuel can be introduced while an intake valve associated with the combustion chamber is open. An advantage of introducing colder fuel into the combustion chamber while the intake valve is still open is it displaces less air since the density of the colder fuel is greater and takes up less volume. Since less air is displaced there is more oxygen available for combustion which improves the efficiency and power of the engine. The load on the engine can be determined as a function of at least one of accelerator pedal position, engine speed, engine torque, manifold air temperature and manifold air pressure. The gaseous fuel can be selected from the list containing natural gas, methane, ethane, propane, butane, hydrogen and mixtures thereof.

In a preferred embodiment, the internal combustion engine can be operated with a variable compression ratio, and the method can further comprise reducing heat transfer to the gaseous fuel when increasing effective compression ratio. The internal combustion engine can be a bi-fuel engine with a variable compression ratio, and the method can further comprise increasing effective compression ratio when fuelling the internal combustion engine with the gaseous fuel. A bi-fuel engine is one that can be fuelled with a gaseous fuel (such as natural gas), or a liquid fuel (such as gasoline), or both the gaseous fuel and the liquid fuel simultaneously.

The amount of heat transferred to the gaseous fuel can be adjusted by at least one of (1) adjusting a heat exchange rate between a heat source and the gaseous fuel, (2) adjusting gaseous fuel flow rate and (3) adjusting residence time of the gaseous fuel in a heat exchanger. The heat source can be heated engine coolant from the water jacket of the engine, and the amount of heat transferred to the gaseous fuel can be controlled by adjusting a heat exchange rate between a flow of the engine coolant and the gaseous fuel thereby adjusting gaseous fuel temperature.

An improved apparatus for operating an engine fuelled with a gaseous fuel and improving volumetric efficiency is provided. There is a vessel for storing the gaseous fuel in a liquid state. A heat exchanging apparatus comprises a heat exchanger and a heat delivery apparatus. The heat exchanger converts the gaseous fuel from the vessel to one of a gas state and a supercritical state. The heat delivery apparatus supplies heat to the heat exchanger for the conversion. A temperature sensor emits signals representative of gaseous fuel temperature downstream of the heat exchanger. A fuel injector introduces the gaseous fuel from the heat exchanger into a cylinder of the engine. A controller is operatively connected with the heat delivery apparatus, the temperature sensor and the fuel injector and programmed for the following operations. To determine a load on the engine as function of engine operating conditions. To determine a target temperature of the gaseous fuel downstream from the heat exchanging apparatus as a function of the load on the engine. To determine actual gaseous fuel temperature downstream of the heat exchanging apparatus as a function of the signals emitted by the temperature sensor. And to adjust an amount of heat delivered by the heat delivery apparatus to the heat exchanger such that the actual gaseous fuel temperature equals the target gaseous fuel temperature to within a predetermined range of tolerance.

The heat delivery apparatus can comprise a diverting valve connecting a water jacket of the engine with the heat exchanging apparatus. The controller is operatively connected with the diverting valve to control engine coolant flow from the water jacket through the heat exchanger. In another embodiment, the heat delivery apparatus comprises an electric heater such that the controller is operatively connected with the electric heater to control a power output of the heater. In yet another embodiment, the heat delivery apparatus comprises a boiler and an adjustable valve between a vapor space in the vessel and the boiler. The controller is operatively connected with the adjustable valve to control boil-off gas flow from the vapor space to the boiler.

A pumping apparatus between the vessel and the heat exchanging apparatus pumps the gaseous fuel through the heat exchanging apparatus. The controller is operatively connected with the pumping apparatus and is programmed to operate the pumping apparatus to adjust residence time of gaseous fuel in the heat exchanger. The fuel injector can be configured in the apparatus to introduce the gaseous fuel upstream of an intake valve or directly into the cylinder. When the fuel injector is configured for directly introducing the gaseous fuel into the cylinder, the controller is further programmed to introduce at least a portion of the gaseous fuel while an intake valve associated with the cylinder is open. The controller is programmed to adjust fuel injector on time as a function of gaseous fuel temperature such that an equivalent amount of gaseous fuel on an energy basis is introduced into the cylinder for given engine operating conditions.

### BRIEF DESCRIPTION OF THE SEVERAL VIEWS OF THE DRAWINGS

FIG. 1 is a schematic view of an engine apparatus according to a first embodiment.

FIG. 2 is a flow chart of an algorithm for controlling the temperature of gaseous fuel in the engine apparatus of FIG. 1.

FIG. 3 is a schematic view of an engine apparatus according to a second embodiment.

FIG. 4 is a schematic view of an engine apparatus according to a third embodiment.

FIG. 5 is a schematic view of an engine apparatus according to a fourth embodiment.

### DETAILED DESCRIPTION

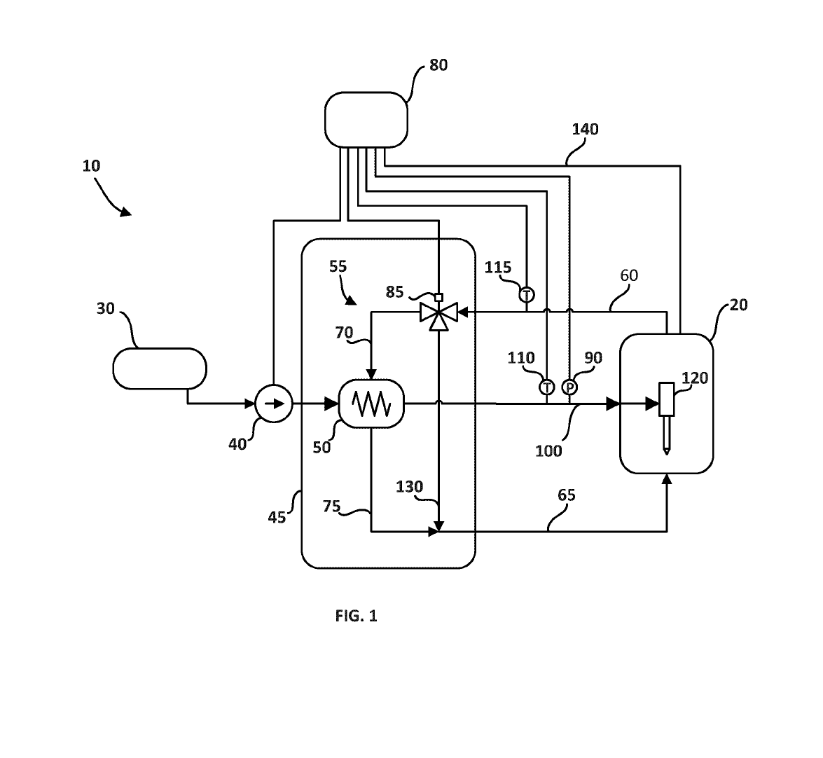

Referring to FIG. 1, there is shown engine apparatus 10 according to a first embodiment. Apparatus 10 comprises internal combustion engine 20 that is fuelled with gaseous fuel from cryogenic vessel 30. In an exemplary embodiment engine 20 is an Otto-cycle engine. However, in different embodiments other types of engines are contemplated such as Diesel-cycle engines. Engine 20 can also be a bi-fuel engine employing a variable compression ratio. The effective compression ratio of the bi-fuel engine can be adjusted by techniques such as variable valve actuation depending on the constitution of the fuel mixture burned by the engine such that the more the bi-fuel engine burns gaseous fuel the more the effective compression ratio is increased. A variety of techniques can be employed to ignite the gaseous fuel in engine 20, and as non-limiting examples of such techniques the gaseous fuel can be ignited by a positive ignition source (e.g. spark igniter, laser igniter), a glow plug or heated surface, a pilot fuel, compression ignition, and a combination of these techniques. Gaseous fuel is stored in vessel 30 in a liquid state, the manner of storing such fuel at cryogenic temperatures is known by those familiar with cryogenic fuel storage technology. Pumping apparatus 40 pumps liquefied gaseous fuel from vessel 30 through heat exchanging apparatus 45, where it undergoes a transition from the liquid state to either the gas or supercritical state, and into piping 100. An accumulator (not shown) can be connected with piping 100 to store a predetermined amount of pressurized gaseous fuel that acts as a buffer to limit pressure fluctuations in piping 100 during transient operating modes of engine 20 and varying downstream demand. In other embodiments piping 100 can be sized accordingly to act as an accumulator. Fuel injector 120 is actuated by controller 80 to introduce gaseous fuel from piping 100 into a cylinder (not shown) of engine 20. Injector 120 can introduce gaseous fuel upstream of an intake valve (not shown) associated with the cylinder, or can introduce gaseous fuel directly into the cylinder. Although only one injector is shown in the illustrated embodiment of FIG. 1, it is understood that most internal combustion engines have a plurality of combustion chambers and can have a plurality of injectors. For example, in the case of engines that employ port injection or direct injection, one injector is normally associated with each combustion chamber.

Heat exchanging apparatus 45 comprises heat exchanger 50 and heat delivery apparatus 55. Heat exchanger 50 receives heat from apparatus 55 for vaporizing the liquefied gaseous fuel received from pumping apparatus 40. In the present embodiment heat delivery apparatus 55 delivers waste heat from engine 20, which is stored in coolant from the water jacket (not shown) of the engine, to heat exchanger 50. Apparatus 55 comprises a diverting valve 85 and piping 70, 75 and 130. Diverting valve 85 operates to control the proportions of engine coolant from piping 60 that flow through piping 70 and 130 respectively. The proportion of engine coolant flowing through piping 70, and consequentially through heat exchanger 50, can vary between 0% and 100% of the engine coolant flowing through piping 60. Controller 80 commands valve 85 to adjust the proportion of engine coolant flowing into piping 70 and heat exchanger 50 as a function of engine operating conditions as will be explained in more detail below. The engine coolant from piping 70 flows through heat exchanger 50 into piping 75, where it is combined with engine coolant flowing in piping 130 (if any) and routed into piping 65 where it is returned to the water jacket. Note that in other embodiments an intermediary heat exchanger may be employed to separate the water jacket coolant loop from the heat exchange loop of apparatus 45.

Electronic controller 80 receives signals from pressure sensor 90 representative of pressure in piping 100 and controls pumping apparatus 40 accordingly to pressurize the gaseous fuel in piping 100 to a predetermined value within a range of tolerance as a function of engine operating conditions. Controller 80 receives signals from temperature sensor 110 representative of the temperature of gaseous fuel in piping 100, and signals from temperature sensor 115 representative of the temperature of engine coolant in piping 60. Signals representative of accelerator pedal position in engine 20 are delivered to controller 80 over signal wire 140. Accelerator pedal position is representative of engine load during steady state conditions and desired engine load during transient conditions when the pedal position changes. Alternatively, or additionally, controller 80 can receive signals representative of throttle position in engine 20, which can also be representative of engine load. Controller 80 also receives signals commonly employed in internal combustion engines such as engine speed, engine torque, manifold air temperature (MAT), manifold air pressure (MAP), pre-ignition and/or knock, exhaust gas oxygen concentration, cylinder pressure and ambient temperature among others. The instantaneous load on engine 20 can be determined by controller 80 using at least some of these signals as would be known to one skilled in the technology. Pre-ignition and/or knock can be detected using a variety of techniques, such as sound-based methods using a microphone as the sensor, or motion-based methods using an accelerometer as the sensor.

Engine volumetric efficiency is a direct function of the density of the air drawn into engine 20. Cooling the air coming into the engine would increase the engine volumetric efficiency and increase engine output power and torque. Additionally, by cooling the intake air the engine would be less prone to pre-ignition and knocking thereby allowing greater compression ratios to be employed that further increase the volumetric efficiency of engine 20. The gaseous fuel temperature downstream of heat exchanger 50 can be controlled as a function of engine operating conditions to cool the air charge into which the gaseous fuel is introduced, since the gaseous fuel is stored at cryogenic temperatures and vaporized before introduction into engine 20. As the gaseous fuel temperature is decreased, and its resistance to pre-ignition and engine knock is increased, the compression ratio of engine 20 can be increased to further improve volumetric efficiency, power output and torque at high(er) load(s). The compression ratio can be increased by changing the geometry of the combustion chamber, and the effective compression ratio can be further adjusted dynamically during engine operation by employing variable valve actuation techniques.

In an exemplary embodiment the gaseous fuel temperature in piping 100 is adjusted by controlling the flow of engine coolant through heat exchanger 50. The temperature of the gaseous fuel can be increased by increasing the flow of engine coolant through heat exchanger 50 thereby providing more heat for vaporization. The heat transfer between engine coolant and gaseous fuel in heat exchanger 50 is increased when more engine coolant flows through piping 70. The greater the heat transfer the greater the heat exchange rate and the greater the temperature rise of gaseous fuel through heat exchanger 50. The temperature of the gaseous fuel can be decreased by decreasing the flow of engine coolant through heat exchanger 50 thereby providing less heat for vaporization. Similarly, the heat transfer is decreased when less engine coolant flows through piping 70 thereby decreasing the heat exchange rate and decreasing the temperature rise of gaseous fuel through heat exchanger 50. Controller 80 can determine the required flow rate of engine coolant through heat exchanger 50 as a function of at least one of the temperature of gaseous fuel in piping 100, the temperature of engine coolant in piping 60, MAT, MAP, engine speed, engine torque, a detected level of pre-ignition and/or knock, ambient temperature, throttle position and pedal position.

As a baseline requirement, the gaseous fuel temperature in piping 100 is maintained above that temperature at which heat exchanger 50 freezes (that is the engine coolant circulating through the heat exchanger freezes). This requirement can be achieved by maintaining the temperature of engine coolant in piping 70 above a predetermined minimum value relative to the flow rate of gaseous fuel through heat exchanger 50. The probability of heat exchanger 50 freezing can be determined as a function of temperature in piping 60, coolant flow rate through piping 70 and gaseous fuel flow rate through heat exchanger 50. In alternative embodiments a temperature sensor can be employed to measure the temperature of coolant in piping 70 directly instead of or in addition to the temperature in piping 60. The gaseous fuel temperature in piping 100 can be as low as the temperature limit for components downstream of heat exchanging apparatus 45, providing heat exchanger 50 does not freeze.

The gaseous fuel in piping 100 is a compressible fluid since it is in a gas or supercritical state. In these states, the density of the gaseous fuel in piping 100 is determined as a function of at least its temperature and pressure and the volume occupied by the gaseous fuel. As the temperature of the gaseous fuel changes according to the technique disclosed herein its density also changes. To accurately introduce a predetermined mass of fuel into the cylinder, the pulse width of the fuel injector actuation signal is adjusted as the gaseous fuel temperature changes (in addition to adjusting the pulse width for pressure changes in gaseous fuel). Alternatively, or additionally, when the fuel injector is capable of partial lift the lift of the needle can be adjusted as gaseous fuel temperature changes. The pulse width is determined as a function of at least gaseous fuel temperature, gaseous fuel pressure, and the mass of gaseous fuel to be introduced into the cylinder. For a given injection pressure and mass of injected fuel, as the temperature of the gaseous fuel in piping 100 increases the pulse width increases, and as the temperature decreases the pulse width decreases. It is possible that the instantaneous gaseous fuel pressure in piping 100 changes when the temperature of gaseous fuel exiting heat exchanger 50 into piping 100 changes. For example, if the flow rate from pumping apparatus 40 is constant within a range of tolerance before and after the temperature of gaseous fuel exiting heat exchanger 50 changes, then the gaseous fuel pressure in piping 100 will also change, which affects gaseous fuel density. To accurately inject a predetermined mass into the cylinder, the pulse width compensates for instantaneous pressure changes of gaseous fuel in piping 100. Normally, the gaseous fuel pressure in piping 100 for steady state engine operating conditions is maintained at a predetermined value within a range of tolerance.

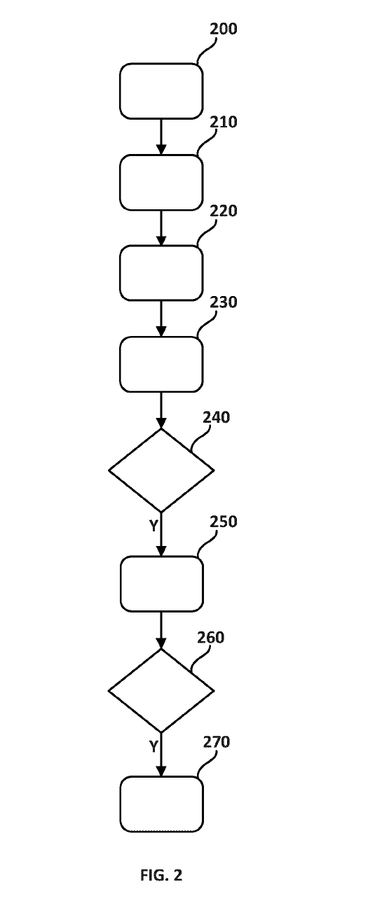

With reference to FIG. 2 there is shown an algorithm performed in controller 80 for controlling the temperature of gaseous fuel in piping 100. In step 200 controller 80 receives the driver pedal position request from engine 20 over signal wire 140 (seen in FIG. 1). In step 210 controller 80 determines a target gaseous fuel temperature set point in piping 100 by way of a look-up table using pedal position as an index into the table. In other embodiments a formula can be employed to determine the target gaseous fuel temperature set point that uses pedal position as a parameter. In still further embodiments other engine operating parameters can be employed to index into tables or in formulas to determine the target gaseous fuel temperature set point. In step 220 controller 80 adjusts valve 85 until gaseous fuel temperature in piping 100 equals the target gaseous fuel temperature to within a predetermined range of tolerance. The pulse widths for injector 120 are determined in step 230 as a function of gaseous fuel temperature, gaseous fuel pressure and the mass of gaseous fuel to be injected. Alternatively, a pulse width temperature correction factor can be determined as a function of at least one of the change in gaseous fuel temperature and the change in gaseous fuel pressure, which can be employed to correct predetermined fuel injector pulse widths. Additionally, or alternatively, when fuel injector 120 is capable of partial lift the partial lift height or correction factor is determined in step 230. The load on engine 20 is compared to a predetermined threshold value in step 240, and when greater than the threshold value, controller 80 commands a change in effective compression ratio in step 250 by adjusting intake valve actuation timing. In step 260 the controller determines whether a threshold level of pre-ignition and/or knock has been detected, and if detected gaseous fuel temperature is decreased in step 270 according to one of the techniques described herein to increase gaseous fuel resistance to pre-ignition and engine knock. Some of the aforementioned steps can be performed in parallel in other embodiments.

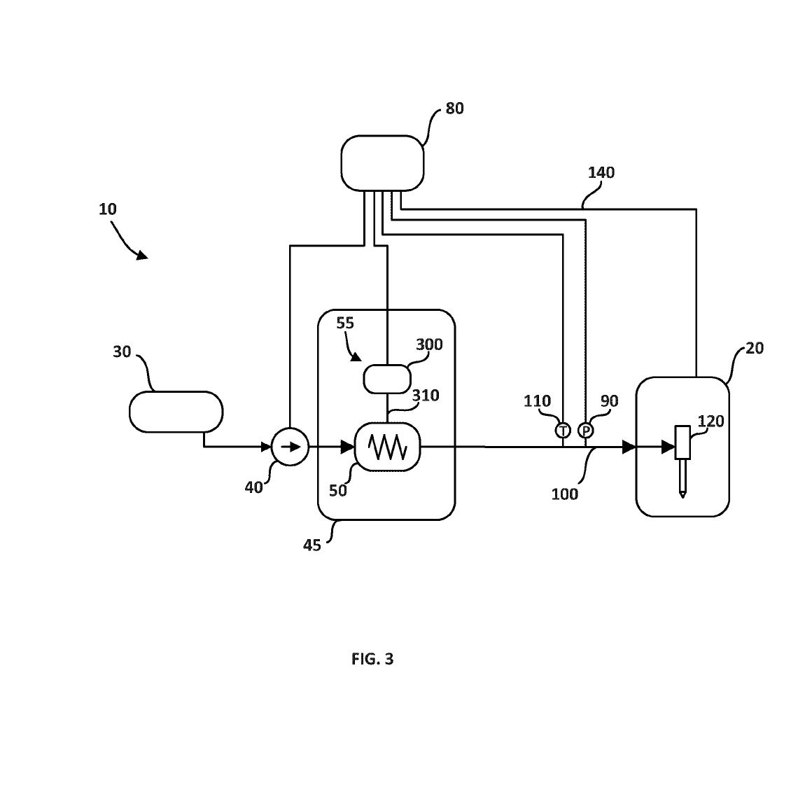

Other embodiments are now discussed where like parts to the first embodiment and amongst all the embodiments have like reference numerals and if previously discussed may not be described in detail if at all. Referring now to FIG. 3, engine apparatus 12 is shown according to a second embodiment where heat delivery apparatus 56 of heat exchanging apparatus 46 comprises an electric heater 300 that provides heat over pathway 310 to heat exchanger 50. The heat from heater 300 can be employed to heat an intermediary heat exchange fluid that circulates between heater 300 and heat exchanger 50, or can be directly transferred to heat exchanger 50 over a material with low thermal resistance. Controller 80 commands the output power of heater 300 over command line 320 according to the algorithm of FIG. 2.

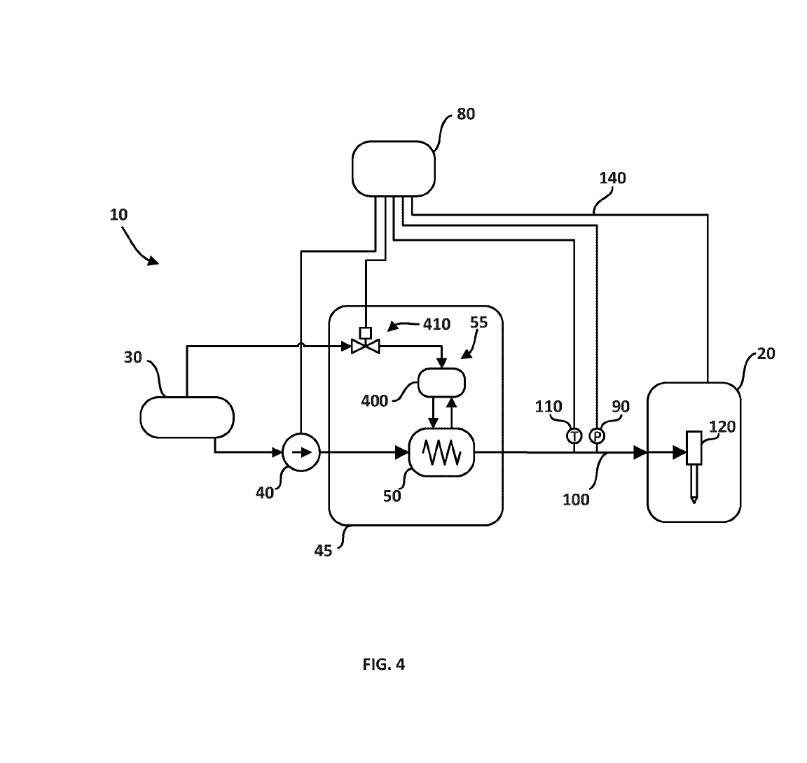

Referring now to FIG. 4, engine apparatus 13 is shown according to a third embodiment where heat delivery apparatus 57 of heat exchanging apparatus 47 comprises boiler 400 which burns boil-off gas from vessel 30 delivered through adjustable valve 410. In other embodiments boiler 400 can burn another fuel type from another vessel. An intermediary heat exchange fluid circulating through boiler 400 and heat exchanger 50 transfers heat from the boiler to the gaseous fuel. Controller 80 commands a flow rate of boil-off gas to boiler 400, thereby controlling the amount heat generated by the boiler, by commanding valve 410 accordingly.

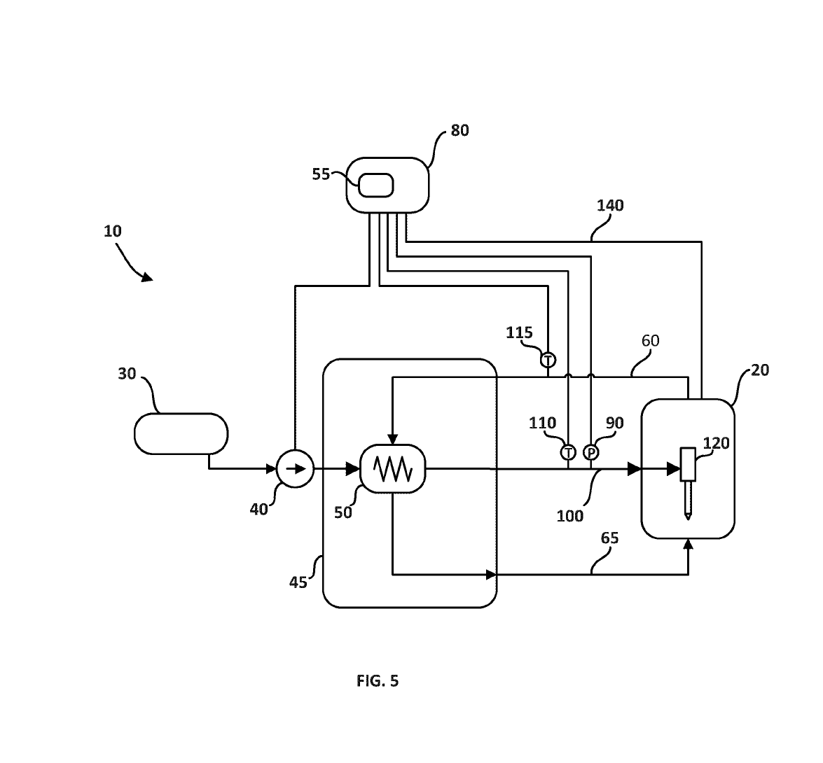

Referring now to FIG. 5, engine apparatus 14 is shown according to a fourth embodiment where coolant from engine 20 flows through piping 60 and heat exchanger 50 to vaporize the gaseous fuel. Heat delivery apparatus 58 comprises an algorithm in controller 80 for controlling the instantaneous gaseous fuel flow rate through heat exchanger 50 of heat exchanging apparatus 48 thereby controlling residence time of gaseous fuel inside the heat exchanger. The greater the residence time of gaseous fuel inside heat exchanger 50 the greater the amount of heat transferred and the greater the temperature of gaseous fuel exiting the heat exchanger into piping 100. During most operating conditions pumping apparatus 40 is not pumping continuously since downstream demand is not at a maximum. In these situations the instantaneous gaseous fuel flow rate can be adjusted by adjusting the speed of pumping apparatus 40 during pumping strokes, while maintaining the overall average pump speed constant thereby keeping the average gaseous fuel flow rate constant. By changing the instantaneous gaseous fuel flow rate through heat exchanger 50 the residence time can be adjusted. When pumping apparatus 40 comprises a reciprocating piston pump, the stroke length can be adjusted to change the residence time of fuel through heat exchanger 50 as described in the Applicant's co-pending patent application titled “Temperature Control of a Fluid Discharged from a Heat Exchanger” filed on Mar. 15, 2013.

In still further embodiments, any combination of heat delivery apparatuses 55, 56, 57 and 58 can be employed for transferring heat to the gaseous fuel. This can be beneficial since depending upon the conditions of internal combustion engine 20 the various heat delivery apparatuses may have varying capacities to transfer heat to the gaseous fuel. For example, upon start-up the engine coolant of the internal combustion engine is relatively low compared to when the engine has been operating for a while. In this circumstance heat delivery apparatuses 56, 57 and 58 may be more capable of supply heat to the gaseous fuel when this is desired.

While particular elements, embodiments and applications of the present invention have been shown and described, it will be understood, that the invention is not limited thereto since modifications can be made by those skilled in the art without departing from the scope of the present disclosure, particularly in light of the foregoing teachings. For example, while the previously described embodiments have been discussed independently, it is possible to combine into further single embodiments any number of these previously discussed techniques for controlling gaseous fuel temperature.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operating an internal combustion engine and improving volumetric efficiency, said method comprising:
storing a gaseous fuel in a liquid state;
determining a load on said internal combustion engine as a function of engine operating conditions;
determining a target temperature for said gaseous fuel that reduces the likelihood of pre-ignition and knock as a function of said load; and
controlling the amount of heat transferred to said gaseous fuel to convert it to one of a gas state and a supercritical state, whereby said gaseous fuel is introduced into said internal combustion engine at said target temperature.

2. The method of claim 1, wherein said target temperature is determined to have a value within a predetermined range of tolerance.

3. The method of claim 1, wherein said internal combustion engine can be operated with a variable compression ratio, and said method further comprises reducing heat transfer to said gaseous fuel when increasing an effective compression ratio.

4. The method of claim 1 wherein said internal combustion engine is a bi-fuel engine with a variable compression ratio, and said method further comprises increasing an effective compression ratio when fuelling said internal combustion engine with said gaseous fuel.

5. The method of claim 1, wherein said amount of heat transferred to said gaseous fuel is adjusted by at least one of adjusting a heat exchange rate between a heat source and said gaseous fuel, adjusting gaseous fuel flow rate and adjusting residence time of said gaseous fuel in a heat exchanger.

6. The method of claim 1, wherein controlling the amount of heat transfer comprises adjusting a heat exchange rate between a flow of engine coolant from a water jacket of said engine and said gaseous fuel thereby adjusting gaseous fuel temperature.

7. The method of claim 1, further comprising decreasing gaseous fuel temperature as said load increases and increasing gaseous fuel temperature as said load decreases.

8. The method of claim 1, further comprising adjusting at least one fuel injector on-time as a function of gaseous fuel temperature and fuel injector partial lift to correct for changes in fuel density.

9.-11. (canceled)

12. The method of claim 1, further comprising determining said load on said engine as a function of at least one of accelerator pedal position, throttle position, engine speed, engine torque, manifold air temperature and manifold air pressure.

13. The method of claim 1, further comprising determining said target temperature as a function of ambient temperature.

14. The method of claim 1, further comprising selecting said gaseous fuel from the list containing natural gas, methane, ethane, propane, butane, hydrogen and mixtures thereof.

15. An apparatus for operating an engine fuelled with a gaseous fuel comprising:
a vessel for storing said gaseous fuel in a liquid state;
a heat exchanging apparatus comprising a heat exchanger and a heat delivery apparatus, said heat exchanger converting said gaseous fuel from said vessel to one of a gas state and a supercritical state, said heat delivery apparatus supplying heat to said heat exchanger for said conversion;
a temperature sensor emitting signals representative of gaseous fuel temperature downstream of said heat exchanger;
a fuel injector for introducing said gaseous fuel from said heat exchanger into a cylinder of said engine; and
a controller operatively connected with said heat delivery apparatus, said temperature sensor and said fuel injector and programmed to:
determine a load on said engine as a function of engine operating conditions;
determine a target temperature of said gaseous fuel downstream from said heat exchanging apparatus as a function of said load on said engine;
determine actual gaseous fuel temperature downstream of said heat exchanging apparatus as a function of said signals emitted by said temperature sensor; and
adjust an amount of heat delivered by said heat delivery apparatus to said heat exchanger such that said actual gaseous fuel temperature equals said target gaseous fuel temperature to within a predetermined range of tolerance.

16. The apparatus of claim 15, wherein said heat delivery apparatus comprises a diverting valve connecting a water jacket of said engine with said heat exchanging apparatus and said controller operatively connected with said diverting valve to control engine coolant flow from said water jacket through said heat exchanger.

17. The apparatus of claim 15, wherein said heat delivery apparatus comprises an electric heater and said controller operatively connected with said electric heater to control a power output of said heater.

18. The apparatus of claim 15, wherein said heat delivery apparatus comprises a boiler and an adjustable valve between a vapor space in said vessel and said boiler, said controller operatively connected with said adjustable valve to control boil-off gas flow from said vapor space to said boiler.

19. The apparatus of claim 15, further comprising a pumping apparatus between said vessel and said heat exchanging apparatus for pumping said gaseous fuel through said heat exchanging apparatus, said controller operatively connected with said pumping apparatus and programmed to operate said pumping apparatus to adjust residence time of gaseous fuel in said heat exchanger.

20. The apparatus of claim 15, wherein said fuel injector is configured for at least one of:
to introduce said gaseous fuel upstream of an intake valve; and
to introduce said gaseous fuel directly into said cylinder.

21. (canceled)

22. The apparatus of claim 20, wherein when said fuel injector directly introduces said gaseous fuel, said controller is further programmed to introduce at least a portion of said gaseous fuel while an intake valve associated with said cylinder is open.

23. The apparatus of claim 15, wherein said controller is further programmed to at least one of:
determine said load on said engine as a function of at least one of accelerator pedal position, throttle position, engine speed, engine torque, manifold air temperature and manifold air pressure;
determine said target temperature as a function of ambient tem temperature; and
adjust fuel injector on time as a function of gaseous fuel temperature such that an equivalent amount of gaseous fuel on an energy basis is introduced into said cylinder for given engine operating conditions.

24.-25. (canceled)

26. The apparatus of claim 12, wherein said heat delivery apparatus comprises at least one of:
(1) a diverting valve connecting a water jacket of said engine with said heat exchanging apparatus and said controller operatively connected with said diverting valve to control engine coolant flow from said water jacket through said heat exchanger;
(2) an electric heater and said controller operatively connected with said electric heater to control a power output of said heater; and
(3) a boiler and an adjustable valve between a vapor space in said vessel and said boiler, said controller operatively connected with said adjustable valve to control boil-off gas flow from said vapor space to said boiler.
